(19) United States
(12) Patent Application Publication
(10) Pub. No.: US 2006/0015426 A1
(43) Pub. Date: Jan. 19, 2006

(54) Risk shifting method for investments in wind power generation

(76) Inventor: David E. Freund, Armonk, NY (US)

Correspondence Address: BAKER & BOTTS, 30 ROCKEFELLER PLAZA, NEW YORK, NY, 10112, US

(21) Appl. No.: 10/894,384

(22) Filed: Jul. 19, 2004

(51) Int. Cl. G06Q 40/00

(52) U.S. Cl. 705/35; 705/38

(57) ABSTRACT

A method for shifting risk in a wind power generation project from an investor to a guarantor. The method includes determining a premium amount to be paid by the investor to the guarantor, determining a total return floor amount, obtaining structural supports including a wind variability swap, manufacturer's warranty and/or insurance regarding the operational or financial risks of carrying out the power generation project. The premium amount is paid to the guarantor in exchange for the guaranteed total return floor amount.

This invention provides a means for an Investor to calculate and regulate an amount of operational risk an Investor is willing to take in wind energy projects while still taking the economic risk of the project. There are two broad types of Investors. There are Debt Investors and Equity Investors. An Equity Investor, as opposed to a Debt Investor, will bear the economic risk of the project. The fact that an Investor uses this invention should not diminish the fact that the Equity Investor is still at risk for the project. The Equity Investor is using this invention to shift the operational risk to the Guarantor. The invention relies on two premises of corporate finance.
1. Investors should try to diminish any risk that they are not in business to take.
2. Different parties view the same risks differently. Due to one party's expertise, they may not feel that a particular risk is material while another party may view the same risk as material.

The risk shifting provided by the invention is a critical element for an Investor since they may view Wind Energy project risk as a material risk that they are not in business to take. This invention/component will provide Investors with the necessary comfort level to commit funds to wind energy projects. Before this invention, Investors needed to accumulate the necessary expertise in wind energy in order to make the proper investment decisions. Until now, this has constricted the number of investors who provide capital for the wind energy projects. The invention provides a minimum total return floor guarantee (“the Guarantee”) providing a quantifiable hedge for operational risk. The downside risk, with this invention, will be the Counterparty Risk (risk that a guarantor will not be able to fulfill its obligations under the Guarantee) of the guarantor rather than the operational risk of a wind power project. Should the counterparty not be able to make timely Guarantee payments, the Investor will need to rely on the returns generated by the project. Counterparty Risk is a risk that institutional Investors are equipped to analyze. Wind power project risk is more difficult for an Investor (without specific expertise) to analyze. This floor can represent one of the following: (i) minimum dollar amount for tax credits earned by an investor based on a project's power sales (ii) pre-tax project cash flow (iii) post-tax project cash flow or (iv) floor for project dividends to Investor, or other metric to be mutually agreed. By means of this invention, an Investor will be able to quantify the risk of their investment. This will be true for a given project for the timeframe covered by the floor. Quantifying risk using this invention is particularly important for Investors who do not have expertise in the area of wind generated power but would like to make investments in this area. The invention is applicable to scenarios where there are one or multiple Investors. It is also applicable for Investors who utilize a direct or indirect interest in a consolidated or non-consolidated special purpose entity such as a Limited Liability Partnership or a Limited Liability Corporation among others.

A Guarantor, as described herein, is part of this invention. To date, no one entity has combined the four main building blocks (“Risk Mitigants”) of this invention in order to provide an Investor with a Guarantee as described herein. The Risk Mitigants are structural supports provided by the following: Wind Variability Swap, Manufacturer's Warranty, Insurance, and Tax Indemnification among Other Structural Supports. Other Structural Supports encompasses any support that a Guarantor perceives as necessary to diminish project risk to an acceptable level.

A Guarantor will be capable of judging whether the Premium amount is satisfactory for the perceived level of risk. (The Premium is the price the Investor is effectively paying a Guarantor for providing a Guaranty.) This decision will be taken on a project-by-project basis. For the right project profile, the risk adjusted return will be extraordinarily high for a Guarantor. The adjusted risk will also need to reflect the Guarantor's Counterparty Risk (the risk that an Investor will not fulfill its obligations under the Guarantee). The reason for this is that a Guarantor can use its expertise to set a dollar floor amount at a level where they feel they are not materially at risk. This judgment will be quantitatively and statistically based on stress tests on the project. These tests will focus on project assumptions. These will be factors such as plant availability based on forecasts for wind speed at the plant site among other things. Guarantor will then judge whether the project cash flows, as supplemented by the structural support, is sufficient to meet the minimum total return floor. If it does not, then a guarantor may look at the present value of the Premiums and compare this sum to the present value of the payments a guarantor forecasts it would have to make to an Investor during the Guarantee Period, this period will be mutually agreed before executing a Guarantee to.

Guarantee Period

The preferred period (“Guarantee Period”) is ten years. The actual Guarantee Period is to be mutually agreed before executing a Guarantee and any Renewal Options, Early Termination Provisions, Default Provisions and all other usual and customary provisions are to be mutually agreed before executing a Guarantee. A Renewal Option is the right for an Investor to extend the Guarantee Period based on a set of criteria that are to be mutually agreed upon before executing a Guarantee. A Guarantor will set the Guarantee Period based on the availability of Risk Mitigants internally and externally—from a third party. For example, if a Wind Variability Swap is only available externally for a specific project for 5 years, and a Guarantor is not comfortable internally taking the wind risk for the subsequent 5 years, then a Guarantor may choose to offer a Guarantee Period of only 5 Years. In this example, A Guarantor may offer a renewal option with pricing to be determined based on the possibility of renewing the external Swap. In this example, it is possible the external swap can be renewed for a subsequent 5 years subject to a re-pricing of the swap premium after the first 5-year period. In this case, a Guarantor may choose to offer a 10-year Guarantee Period with the stipulation that any increased pricing for the Risk Mitigants will be passed on to Investors. All of the Risk Mitigants will be examined in this manner in order to decide on a Guarantee Period and Renewal Options.

The dollar amount of the premiums will, in part, be determined by supply and demand. There is a limited supply of able Guarantor's. In addition, the number of projects a Guarantor can provide a Guarantee for is limited. This is based on a Guarantor's total accumulation of risk for wind energy. This risk level will include all of a Guarantor's exposure to wind energy risk. Due to this, demand for a Guarantor may outpace supply.

Section 45 Tax Credits

An Equity Investor in this area may qualify for production tax credits under Section 45 of the Internal Revenue Code.

Section 45 provides a federal income tax credit for electricity produced from renewable resources, including wind, and sold to an unrelated person.

The same project may also qualify for state tax credits depending on the location of the project. Section 45(c)(1) defines “qualified energy resources” to include wind. Section 45(c)(3)(A) defines a “qualified facility” in the case of a facility using wind to produce electricity as any facility owned by the taxpayer that is originally placed in service after Dec. 31, 1993, and before Jan. 1, 2002.

Tax Risk

Tax risk can be divided into two sub-parts: (a) the risk that the Equity Investor will not have sufficient taxable income to use the credits or carry them forward, and (b) the risk that the Equity Investor will not be able to use the credits due to non-conformity with Section 45 of the IRS Tax Code.
Sub-part (a) Equity Investor will have to take the risk that they do not have sufficient taxable income. Preferred embodiment is that they have sufficient taxable income to use the credits as they are generated. Need to factor in the possibility that they may have to carry credits forward.
Sub-part (b) Either Guarantor or Equity Investor will take this risk. In either case, the party taking the risk may seek to insure against this risk. A Debt Investor may require this insurance regardless of whether they are party to a Guarantee or not.
   Novel, Useful and Unobvious Criteria
A) Novel: This invention has not been used in the wind power generation industry before, and it is tailored to meet the nuances of this specific industry. It utilizes the technology of a well-known financial derivative known as a total return floor in a new and unique way. Each one of the components of the invention exists. However, they have never been combined in this particular way to provide this particular output: a quantifiable shifting of operational risk from an Investor to a Guarantor. Existing technologies are used as building blocks to produce an invention that effectively shifts operational risk by creating the role of a Guarantor as described herein. There are a limited number of companies that are capable of being a Guarantor. These companies possess expertise in wind energy and may be able to internally provide one or more of the structural enhancements described below. To this point in time, no one has combined all of these elements into one simplified Guarantee.
B) Useful: This simplification, in and of itself, makes this a useful invention. An Investor normally needs to become familiar with project risk. However, the risk analysis will now be centered on a Guarantor's Counterparty Risk. This makes for a much easier presentation to a Board of Directors of a Fortune 1000 company. The rationale for investing will be centered on something that is widely understood by corporate board members. The economic viability of wind energy is not widely understood and will fortunately not be the only deciding factor. An Equity Investor ultimately bears the project risk, so it will still be factored into the decision making process. This invention will make it possible for Fortune 1000 companies to invest capital in this sector. This invention is also useful for developers of wind energy projects. This is because a knowledgeable Guarantor will be deeply involved with the negotiation of project documents (alongside or in place of an Investor). The developer will not have to educate a newcomer to the market. This will streamline the documentation and due diligence processes.
C) Unobvious: The need for a risk shifting mechanism has existed at least since the operative date of the Section 45 tax credits on Dec. 31, 1993. Since then, Institutional Investors have been seeking an invention that would effectively shift the operational risk of a wind energy project. Even so, this solution, using parts of existing financial technology, has not previously been adapted to the wind power generation industry. This invention will remove the major constraint for Fortune 1000 companies to invest in wind energy.

### SCHEMATIC OF INVENTION

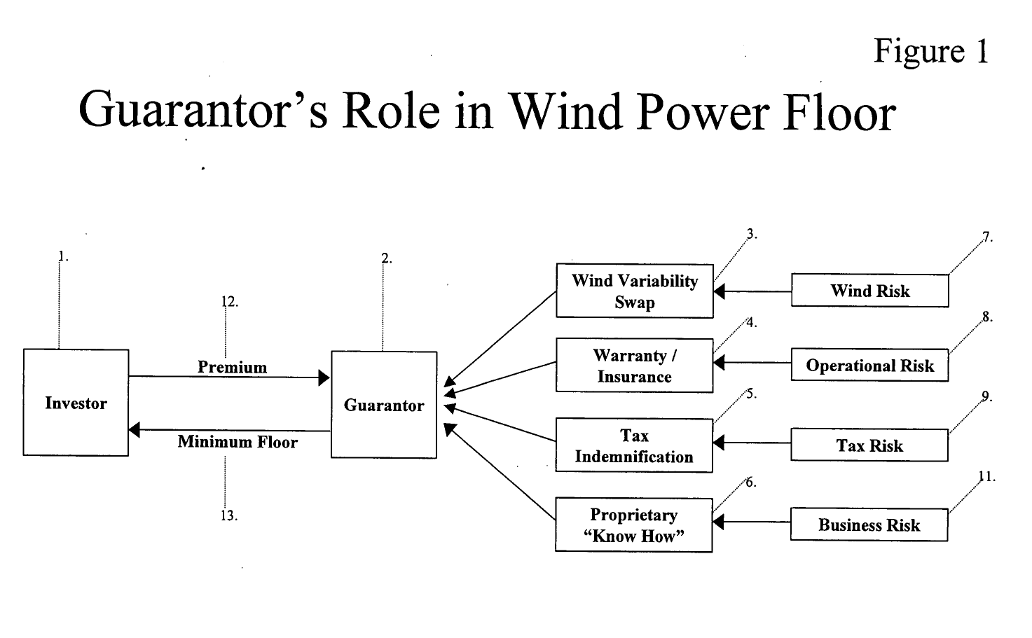

Attached is a diagram outlining this invention (FIG. 1). A guarantor (FIG. 1, 2.) provides an Investor with a Guarantee (either corporate, backed by a letter of credit or other acceptable collateral) stating that a guarantor will ensure that an Investor (FIG. 1, 1.) receives cash flow from its investment in the project equal to at least the Minimum Total Return (FIG. 1, 13.). The dollar amount of the Guarantee will be equal to either: (i) a minimum dollar amount for tax credits earned by an investor based on a project's power sales (ii) a pre-tax project cash flow amount (iii) post-tax project cash flow amount, or (iv) a dollar floor amount for project dividends to Investor. If it is calculated on an after-tax basis, then it will include the after-tax value of the production tax credits that may be available on the state and/or federal level. For the purposes of this invention, it will then be assumed that any Equity Investor in the project has sufficient taxable income to fully utilize the production tax credits when generated without having to carry the credits forward. This is the preferred embodiment. Different scenarios can be analyzed taking into account the possibility that the Investor may need to carry the tax credits forward. An alternative embodiment would be for a guarantor to provide this invention to Debt Investors instead of to an Equity Investor, or to a combination of Investors (both Debt and Equity).

Floor Level

A Guarantor will set a Guarantee floor level such that a Guarantor perceives its level of risk to be relatively inconsequential. The Guarantee level needs to be set low enough so that a guarantor can be confident that the floor will be met from operational cash flow, production tax credits, and the structural support provided by the following Risk Mitigants: Wind Variability Swap (FIG. 1, 3) Warranty and Insurance (FIG. 1, 4) and Tax Indemnification (FIG. 1, 5) among other structural project supports. This level of confidence can be statistically quantified using a confidence interval. Investor will pay any associated costs on a pass-through basis. This includes any costs for any Risk Mitigants that a Guarantor provides internally. Guarantor will be the beneficiary for all of the above and may choose to be actively involved in negotiating all associated documentation. Guarantor will use its knowledge to evaluate project business risks such as Transmission Risk and Power Purchase Agreement/Offtake Risk and may choose to be involved in negotiating the documentation for these project documents. Guarantor may seek to add additional structural mitigants with additional costs to be passed through to Investor. Guarantor will then take any residual business risk in return for receiving a Premium over and above associated costs. The Premium is the price the Investor is effectively paying a Guarantor for providing a Guaranty. Said Premium will be paid on a regular basis throughout the Guarantee Period.

A guarantor will be able to produce this invention based on its ability to statistically quantify the risks involved with undertaking a wind power project. Based on a guarantor's proprietary expertise, a guarantor will be able to assess the level of risk and provide an appropriate dollar amount for the floor based on this assessment. The preferred embodiment is that a guarantor provides a total return floor level where, based on a guarantor's proprietary knowledge, they are able to conclude that they are not taking material risk. The price level for the Premium will reflect a guarantor's perceived level of risk. This embodiment can also be classified as a new and unique “structured merchant energy product”. This classification is used by professional commodity traders and may be confusing/misleading to professionals in the utility industry or financial services sector. The term refers to a product sold by a trading company where the trading company has hedged all of its risks. The return to the trading company, if the previous statement is true, will be the net present value of the premium payments discounted at an appropriate discount rate.

The preferred embodiment is as described above. All of the support flows through a guarantor. However, an Investor may choose to disaggregate the components of the invention. For example, an Equity Investor may choose to separately arrange for any of the structural elements such as Tax Indemnification among other things.

Another embodiment would have a guarantor forming a direct or indirectly controlled special purpose entity such as a captive insurance company to provide the Guarantee. Said special purpose entity would then be the beneficiary of all structural support applicable to Investors interest in a project and would also require support from a highly rated entity within the Parent company's corporate structure if not from the parent company itself.

Operation of Invention

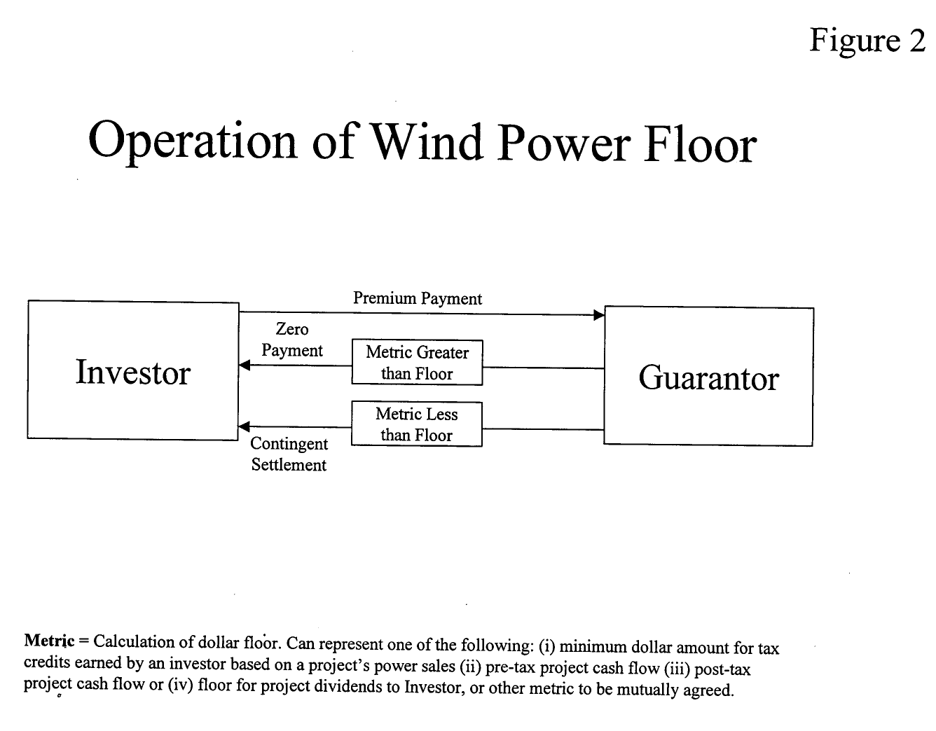

1. A Guarantor will agree that a particular project is economically viable. They will be willing to Guarantee a dollar floor amount based on the analysis outlined above. Some projects will not be viable for this invention.
2. An Investor and a Guarantor will mutually agree, for each period in which the Guarantee is in place, on a dollar amount for the Minimum Total Return Floor (see FIG. 2) for one of the permutations described above) and for the dollar amount of the Premium Payments. The Premium Payments will be based on a Guarantor's perceived level of risk combined with supply and demand for the invention. The above parties will also agree on whether this amount will represent pre-tax cash flow or after-tax cash flow from the project.
3. Before entering into the Minimum Total Return Floor, both parties will mutually agree on the terms and timing for reporting, reconciliation, and Contingent Settlement payment procedure for each payment period, such period to be mutually determined. A Guarantor will make calculations based on information from the reporting date. This information is to be from a mutually agreed before executing a Guarantee upon source. A Guarantor, or another mutually agreed before executing a Guarantee upon party, will calculate the actual dollar amounts from the reporting date and compare them to one of the following (based on the specific embodiment of the invention) (i) minimum dollar amount for tax credits earned by an investor based on a project's power sales (ii) pre-tax project cash flow (iii) post-tax project cash flow or (iv) floor for project dividends or other metric to be mutually agreed before executing a Guarantee upon. If the actual dollar amount is less than the Guaranteed amount, then a Guarantor will make a Contingent Settlement payment to the investor equal to the difference. (See This payment date will be a mutually determined date. Alternatively, if a Guarantor is required to make a payment on a payment date, they may agree to defer payment to a future period in return for a reduction in the Premium Payment for future period(s). This option is to be mutually agreed before executing a Guarantee. If both parties are members of the International Swaps and Derivatives Association (“ISDA”) then ISDA derivatives documentation may be used and modified with an appropriate ISDA Supplement.

What is claimed is:

1. A method for shifting at least a portion of the risk of an investment in a wind power generation project from an investor to a guarantor, comprising:
a) determining a premium amount to be paid by an investor in said project to a guarantor;
b) calculating a total return floor amount equal to an amount selected from the group consisting of: a minimum dollar amount for tax credits earned based on said project's power sales; a pre-tax cash flow amount associated with said project; a post-tax cash flow amount associated with said project; and a dollar floor amount for project dividends to be paid to said investor;
c) obtaining a wind variability swap associated with at least one site where said project is located;
d) obtaining a warranty regarding power generation equipment used at at least one site where said project is located;
e) obtaining an insurance policy regarding at least one operational risk component associated with said project;
f) wherein said investor pays said premium amount to said guarantor in exchange for at least one guaranteed payment, said at least one guaranteed payment totaling at least said total return floor amount calculated in said step b).
